(19) United States
(12) Patent Application Publication
(10) Pub. No.: US 2014/0181672 A1
(43) Pub. Date: Jun. 26, 2014

(54) INFORMATION PROCESSING METHOD AND ELECTRONIC APPARATUS

(71) Applicants: LENOVO (BEIJING) CO., LTD., Beijing (CN); BEIJING LENOVO SOFTWARE LTD., Beijing (CN)

(72) Inventors: Chao ZHANG, Beijing (CN); Ge GAO, Beijing (CN); Qianying WANG, Beijing (CN)

(73) Assignees: LENOVO (BEIJING) CO., LTD., Beijing (CN); BEIJING LENOVO SOFTWARE LTD., Beijing (CN)

(21) Appl. No.: 14/134,213

(22) Filed: Dec. 19, 2013

(30) Foreign Application Priority Data
Dec. 20, 2012 (CN) 201210560254.X
Dec. 20, 2012 (CN) 201210560674.8

(51) Int. Cl. G06F 3/16

(52) U.S. Cl. CPC G06F 3/167
USPC 715/728

(57) ABSTRACT

The present disclosure discloses an information processing method and an electronic apparatus, for solving a technical problem that when a user inputs a voice instruction different from the fixed voice instruction due to incapability of remembering the fixed voice instruction, the electronic devices cannot respond or will mistakenly respond. The method including determining a current application corresponding to a current application interface on the display unit as a first application, the current application interface being a first application interface to which the first application corresponds; obtaining M input objects on the first application interface, M being an integer equal to or larger than one; processing the M input objects to obtain M pieces of prompt information of M character phrases corresponding to the M input objects, the M pieces of prompt information being capable of being displayed on the display unit.

### CROSS REFERENCE TO RELATED APPLICATIONS

This application claims the benefit under 35 U.S.C. §119(a) of Chinese Patent Application No. 201210560254.X, filed on Dec. 20, 2012, and Chinese Patent Application No. 201210560674.8, filed on Dec. 20, 2012, the entire disclosures of which are incorporated by reference herein in their entireties.

### TECHNICAL FIELD

The present disclosure relates to the field of information technology, and in particular to an information processing method and an electronic apparatus.

### BACKGROUND

With the continuous development of information technology, more and more powerful electronic apparatus that can achieve various functions emerge one after another, such as a smart mobile phone, a tablet PC, a smart TV, a laptop, and so on.

Among the multiple functions that electronic apparatus have, the voice instruction function is applied to more and more electronic apparatus, such as a television with voice instruction function, a tablet PC with voice instruction function, or a smart mobile phone with voice instruction function.

Take the tablet PC with voice instruction function as example. A user can control the tablet PC by way of voice, for instance, when the tablet PC is playing a first song by using music player software, the user can input a voice instruction of “next song” to control the tablet PC to play a second song next to the first song.

However, in the prior art, it is impossible to accurately understand meaning of the user with a simple semantic analysis being adopted. For instance, when the user inputs a voice instruction of “the first song does not sound great, change to the second song for me,” the tablet PC just cannot accurately understand the meaning of the user, and it is very likely not to play the second song.

To solve this technical problem, the prior art usually adopts a mode of fixed voice instruction, that is, the voice instruction of playing the next song is fixed to “next song,” so when the user inputs the voice instruction of “next song,” the tablet PC will be able to recognize, and play the second song next to the first song.

In the prior art, since the mode of fixed voice instruction is adopted, there is a technical problem when the user inputs a voice instruction different from the fixed voice instruction due to incapability of remembering the fixed voice instruction. The electronic apparatus cannot respond or will mistakenly respond. Meanwhile for the user, memorizing cost is increased and user experience is decreased.

In addition, in the prior art, when the user opens multiple video files to be displayed by running video player software on the electronic apparatus, these video files will be displayed on a display screen of the electronic apparatus as thumbnails or thumbnails plus texts. When these video files are movies, the movies are displayed on the display screen, which include Heroes, Air Force One, Harry Potter and the Sorcerer's Stone, Under the Hawthorn Tree, and The Dawns Here Are Quiet, etc. In this case, if the user needs to determine a movie to be played through a voice instruction, he/she needs to input a full name, such as “Harry Potter and the Sorcerer's Stone.” Thus, it can be seen that the prior art has a technical problem when the input mode is not straightforward.

### SUMMARY

Embodiments of the present disclosure provide an information processing method and an electronic apparatus, for solving the technical problem that when the user inputs a voice instruction different from the fixed voice instruction due to incapability of remembering the fixed voice instruction, the electronic apparatus cannot respond or will mistakenly respond.

To solve the above technical problem, in an aspect, the embodiments of the present disclosure provide an information processing method applied to an electronic apparatus, including a display unit, the method including determining a current application corresponding to a current application interface on the display unit as a first application, the current application interface being a first application interface to which the first application corresponds; obtaining M input objects on the first application interface, M being an integer equal to or larger than one; and processing the M input objects to obtain M pieces of prompt information of M character phrases corresponding to the M input objects, the M pieces of prompt information being capable of being displayed on the display unit, wherein after an i-th piece of voice information corresponding to an i-th character phase in the M character phrases is recognized by the electronic apparatus, the electronic apparatus can operate an i-th input object corresponding to the i-th character phase, i is any positive integer less than or equal to M.

Alternatively, the determining a current application corresponding to a current application interface on the display unit as a first application specifically includes obtaining at least one active application that is running in the electronic apparatus; obtaining from the current application interface a recognition parameter information for recognizing what type of application the current application corresponding to the current application interface is; and determining the current application as the first application from among the at least one active application based on the recognition parameter information.

Alternatively, when the recognition parameter information specifically is name of the current application or file information of a file opened in the current application, the determining the current application as the first application from among the at least one active application based on the recognition parameter information specifically is determining the current application as the first application corresponding to the name of the current application from among the at least one active application based on the name of the current application; or determining the current application as the first application corresponding to the file information from among the at least one active application based on the file information.

Alternatively, the obtaining M input objects on the first application interface specifically includes obtaining K first display objects corresponding to operation instructions on the first application interface; obtaining J second display objects corresponding to file objects on the first application interface, wherein the sum of K and J is M, and K or J is an integer greater than or equal to zero; and obtaining the M input objects by obtaining the K first display objects and the J second display objects.

Alternatively, processing the M input objects to obtain M pieces of prompt information of M character phrases corresponding to the M input objects specifically includes obtaining K first operation instruction character phrases that are for describing the operation instructions and to which K first operation instructions corresponding to the K first display objects correspond based on a correspondence between the display objects and the operation instructions, and obtaining K pieces of prompt information corresponding to the K first operation instruction character phrases based on the K first operation instruction character phrases; and obtaining J second operation instruction character phrases that are for describing file objects and correspond to the J second display objects, and obtaining J pieces of prompt information corresponding to the J second operation instruction character phrases based on the J second operation instruction character phrases.

Alternatively, the obtaining K first operation instruction character phrases that are for describing operation instructions and to which K first operation instructions corresponding to the K first display objects correspond based on a correspondence between the display objects and the operation instructions specifically includes obtaining the K first operation instructions corresponding to the K first display objects based on a correspondence between the display objects and the operation instructions; parsing meaning of the K first operation instructions to obtain K strings of text information for describing meaning of the operation instructions; and obtaining the K first operation instruction character phrases corresponding to the K first display objects based on the K strings of text information, each of the K first operation instruction character phrases being different from the other first operation instruction character phrases in the K first operation instruction character phrases.

Alternatively, the character length of at least the first one of the K first operation instruction character phrases is less than that of the first string of text information corresponding to the first one of the K first operation instruction character phrases in the K strings of text information.

Alternatively, the K first display objects specifically are icon display objects, text display objects, or icon plus text display objects.

Alternatively, the obtaining J second operation instruction character phrases that are for describing file objects and correspond to the J second display objects specifically includes obtaining J strings of text information for describing file objects and corresponding to the J second display objects; and obtaining J second operation instruction character phrases corresponding to the J second display objects based on the J strings of text information, each of the J second operation instruction character phrases being different from the other second operation instruction character phrases in the J second operation instruction character phrases.

Alternatively, character length of at least the first one of the J second operation instruction character phrases is less than that of the first string of text information corresponding to the first one of the second operation instruction character phrases in the J strings of text information.

Alternatively, the J second display objects specifically are icon display objects, text display objects, or icon plus text display objects.

Alternatively, the M pieces of prompt information specifically are M character phrases having a highlight display effect; or M character phrases having a shadowed display effect; or M character phrases and M pieces of voice prompt information of the M character phrases that can be played in a voice output unit of the electronic apparatus.

In the above information processing method, the processing the M input objects to obtain M pieces of prompt information of M character phrases corresponding to the M input objects may include obtaining a first character string corresponding to one of the M input objects and including S characters; processing the first character string and generating a second character string corresponding to the first character string, wherein the second character string includes T characters, S and T are an integer equal to or greater than one, and T is less than or equal to S; and determining that the second character string corresponds to one of the input objects, the second character string being for triggering a corresponding input object when a voice input is received and voice matching conducted based on the second character string succeeds.

In the above information processing method, processing the first character string and generating a second character string corresponding to the first character string may include processing the first character string according to a predefined rule and generating the second character string; the predefined rule may be when the number of characters of the first character string is more than a preset number N, determining that the second character string is the first to N characters of the first character string; when the number of characters of the first character string is less than or equal to the preset number N, determining that the second character string is the S characters of the first character string, N being a positive integer; alternatively, the predefined rule may be extracting a keyword in the first character string and determining that the second character string is characters to which the keyword of the first character string corresponds.

In the above information processing method, each of the M input objects may correspond to one first character string, obtaining the first character string may include obtaining first character strings corresponding to each of the input objects to form a first character string library including a plurality of first character strings. The processing the first character string and generating a second character string corresponding to the first character string may include processing each of the plurality of first character strings and generating second character strings corresponding to each of the first character strings, to form a second character string library including a plurality of second character strings.

The above information processing method may further include obtaining a triggering instruction for activating a voice recognition function; displaying a corresponding prompt information at a position of a corresponding input object on the current application interface in response to the triggering instruction.

In another aspect, the embodiments of the present disclosure also provide an electronic apparatus including a display unit, the electronic apparatus further including a determining unit for determining a current application corresponding to a current application interface on the display unit as a first application, the current application interface being a first application interface to which the first application corresponds; an obtaining unit for obtaining M input objects on the first application interface, M being an integer equal to or larger than one; and a processing unit for processing the M input objects to obtain M pieces of prompt information of M character phrases corresponding to the M input objects, the M pieces of prompt information being capable of being displayed on the display unit, wherein after an i-th piece of voice information corresponding to an i-th character phase in the M character phrases is recognized by the electronic apparatus, the electronic apparatus can operate an i-th input object corresponding to the i-th character phase, i is any positive integer less than or equal to M.

Alternatively, the determining unit specifically includes a first obtaining sub-unit for obtaining at least one active application that is running in the electronic apparatus; a second obtaining sub-unit for obtaining recognition parameter information for recognizing what type of application the current application corresponding to the current application interface is from the current application interface; and a determining sub-unit for determining the current application as the first application from among the at least one active application based on the recognition parameter information.

Alternatively, when the recognition parameter information specifically is name of the current application or file information of a file opened in the current application, the second obtaining sub-unit specifically is an application name determining sub-unit for, based on the name of the current application, determining the current application as the first application corresponding to the name of the current application from among the at least one active application; or a file name determining sub-unit for, based on the file information, determining the current application as the first application corresponding to the file information from among the at least one active application.

Alternatively, the obtaining unit specifically includes a third obtaining sub-unit for obtaining K first display objects corresponding to operation instructions on the first application interface; a fourth obtaining sub-unit for obtaining J second display objects corresponding to file objects on the first application interface, wherein the sum of K and J is M, and K or J is an integer greater than or equal to zero; and a fifth obtaining sub-unit for obtaining the M input objects by obtaining the K first display objects and the J second display objects.

Alternatively, the processing unit specifically includes a first processing sub-unit for, based on a correspondence between the display objects and operation instructions, obtaining K first operation instruction character phrases that are for describing operation instructions and to which K first operation instructions corresponding to the K first display objects correspond, and for obtaining K pieces of prompt information corresponding to the K first operation instruction character phrases based on the K first operation instruction character phrases; and a second processing sub-unit for obtaining J second operation instruction character phrases that are for describing the file objects and correspond to the J second display objects, and obtaining J pieces of prompt information corresponding to the J second operation instruction character phrases based on the J second operation instruction character phrases.

Alternatively, the first processing sub-unit specifically includes a first obtaining module for obtaining the K first operation instructions corresponding to the K first display objects based on a correspondence between the display objects and the operation instructions; a parsing module for parsing meaning of the K first operation instructions to obtain K strings of text information for describing meaning of operation instructions; a second obtaining module for obtaining the K first operation instruction character phrases corresponding to the K first display objects based on the K strings of text information, wherein each of the K first operation instruction character phrases is different from the other first operation instruction character phrases in the K first operation instruction character phrases; and a third obtaining module for obtaining K pieces of prompt information corresponding to the K first operation instruction character phrases based on the K first operation instruction character phrases.

Alternatively, character length of at least the first one of the K first operation instruction character phrases is less than that of the first string of text information corresponding to the first one of the K first operation instruction character phrases in the K strings of text information.

Alternatively, the K first display objects specifically are icon display objects, text display objects, or icon plus text display objects.

Alternatively, the second processing sub-unit specifically includes a fourth obtaining module for obtaining J strings of text information describing file objects and corresponding to the J second display objects; a fifth obtaining module for obtaining J second operation instruction character phrases corresponding to the J second display objects based on the J strings of text information, wherein each of the J second operation instruction character phrases is different from the other second operation instruction character phrases in the J second operation instruction character phrases; and a sixth obtaining module for obtaining J pieces of prompt information corresponding to the J second operation instruction character phrases based on the J second operation instruction character phrases.

Alternatively, character length of at least the first one of the J second operation instruction character phrases is less than that of the first string of text information corresponding to the first one of the second operation instruction character phrases in the J strings of text information.

Alternatively, the J second display objects specifically are icon display objects, text display objects, or icon plus text display objects.

Alternatively, the M pieces of prompt information specifically are M character phrases having a highlight display effect; or M character phrases having a shadowed display effect; or M character phrases and M pieces of voice prompt information of the M character phrases that can be played in a voice output unit of the electronic apparatus.

In the above electronic apparatus, the M input objects may include J second display objects, the processing unit may include: a first sub-unit for obtaining a first character string corresponding to one of the J second display objects, the first character string including S characters; a second sub-unit for processing the first character string and generating a second character string corresponding to the first character string, wherein the second character string includes T characters, S and T are an integer equal to or greater than one, and T is less than S; and a third sub-unit for determining that the second character string corresponds to the second display object, the second character string being for triggering the second display object when a voice input is received and voice matching conducted based on the second character string succeeds.

In the above in electronic apparatus, the second sub-unit may process the first character string according to a predefined rule and generating the second character string, the predefined rule may be when the number of characters of the first character string is more than a preset number N, determining that the second character string is first to N characters of the first character string; when the number of characters of the first character string is less than or equal to the preset number N, determining that the second character string is the S characters of the first character string, N being a positive integer; alternatively, the predefined rule may be extracting a keyword in the first character string and determining that the second character string is characters to which the keyword of the first character string corresponds.

In the above electronic apparatus, each of the M input objects corresponds to one first character string. The first sub-unit can obtain the first character string as follows obtaining first character strings corresponding to each of the input objects to form a first character string library including a plurality of first character strings. The second sub-unit may process each of the plurality of first character strings and generating second character strings corresponding to each of the first character strings, to form a second character string library including a plurality of second character strings.

The above electronic apparatus may further include a voice activating unit for obtaining a triggering instruction for activating a voice recognition function; and a prompt display unit for, in response to the triggering instruction, displaying corresponding prompt information at a position of a corresponding input object on the current application interface.

Through one or more of the technical solutions provided by the embodiments of the present disclosure, at least the following technical effects can be achieved.

Since, through the methods of the embodiments of the present disclosure, character phrases corresponding to an input object can be finally displayed on the display unit of the electronic apparatus, such as, with respect to a “Back” icon on a player interface corresponding to a video player client, after the technical solutions of the present disclosure are implemented, besides that the icon is still displayed on the player interface, a corresponding text phrase, such as “Back,” will be displayed at an upper, lower, left, or right side of the icon, which facilitates the user making voice input accurately, and thereby solves the technical problem that when the user inputs a voice instruction different from the fixed voice instruction due to incapability of remembering the fixed voice instruction, the electronic apparatus cannot respond or will mistakenly respond, and further achieves the technical effect that the user is prompted accurately through the character phrases, and a proper response can be made when the user inputs a voice instruction.

Since the methods according to the embodiments of the present disclosure can output character phrases for a file object, and the character phrases are determined under the premise of being different from the character phrases of other file objects, a principle of simplification is adopted, such as, with respect to the movie “Harry Potter and the Sorcerer's Stone,” the corresponding text phrase is “Harry Potter,” so that the electronic apparatus is capable of determining the movie “Harry Potter and the Sorcerer's Stone” when collecting the voice information “Harry Potter,” and thereby solves the technical problem that the input mode is not straightforward in the prior art, and further achieves the technical effect of adopting straightforward input mode and improving user experience.

### BRIEF DESCRIPTION OF THE DRAWINGS

FIG. 1 is a flowchart of a method in the embodiments of the present disclosure;

FIG. 2 is a diagram of a first interface when an application is running at a video player client in the embodiments of the present disclosure;

FIG. 3 is a diagram of a second interface when an application is running at a video player client in the embodiments of the present disclosure;

FIG. 4 is a flowchart of step S10 in the embodiments of the present disclosure;

FIG. 5 is a flowchart of step S20 in the embodiments of the present disclosure;

FIG. 6 is a flowchart of step S30 in the embodiments of the present disclosure;

FIG. 7 is a flowchart of a method 200 for providing software operation assistance by way of voice according to the embodiments of the present disclosure;

FIG. 8 is a schematic diagram of a display interface for prompting the second character string according to the embodiments of the present disclosure;

FIG. 9 is a block diagram of an electronic apparatus in the embodiments of the present disclosure; and

FIG. 10 is an exemplary structural block diagram of apparatus 300 providing software operation assistance by way of voice according to the embodiments of the present disclosure.

### DETAILED DESCRIPTION

The embodiments of the present disclosure provide an information processing method and an electronic apparatus, for solving the technical problem that when the user inputs a voice instruction different from the fixed voice instruction due to incapability of remembering the fixed voice instruction, the electronic apparatus cannot respond or will mistakenly respond.

To solve the above technical problem, the general concepts of technical solutions of the embodiments of the present disclosure are as follows.

There is provided an information processing method applied to an electronic apparatus including a display unit, the method including determining a current application corresponding to a current application interface on the display unit as a first application, the current application interface being a first application interface to which the first application corresponds; obtaining M input objects on the first application interface, M being an integer equal to or larger than one; and processing the M input objects to obtain M pieces of prompt information of M character phrases corresponding to the M input objects, the M pieces of prompt information being capable of being displayed on the display unit, wherein after an i-th piece of voice information corresponding to an i-th character phase in the M character phrases is recognized by the electronic apparatus, the electronic apparatus can operate an i-th input object corresponding to the i-th character phase, i is any positive integer less than or equal to M.

Since, through the methods of the embodiments of the present disclosure, character phrases corresponding to an input object can be finally displayed on the display unit of the electronic apparatus, for instance, with respect to a “Back” icon on a player interface corresponding to a video player client, after the technical solutions of the present disclosure are implemented, besides that the icon is still displayed on the player interface, a corresponding text phrase, such as “Back,” will be displayed at an upper, lower, left, or right side of the icon, which facilitates the user making voice input accurately, and thereby solves the technical problem that when the user inputs a voice instruction different from the fixed voice instruction due to incapability of remembering the fixed voice instruction, the electronic apparatus cannot respond or will mistakenly respond, and further achieves the technical effect that the user is prompted accurately through the character phrases, and a proper response can be made when the user inputs a voice instruction.

To enable a person of ordinary skill in the art to better understand the technical solutions in the embodiments of the present disclosure, detailed description will be provided in conjunction with the accompanying drawings hereinafter.

An information processing method in the embodiments of the present disclosure is applied to an electronic apparatus having a voice instruction function, which usually is achieved by way of recognizing by a voice recognition engine a voice instruction collected by a voice collecting device in specific implementations. To be specific, in the embodiments of the present disclosure, the electronic apparatus may be a tablet PC, a smart TV, or a smart mobile phone, a laptop computer, and the voice collecting device may be a microphone.

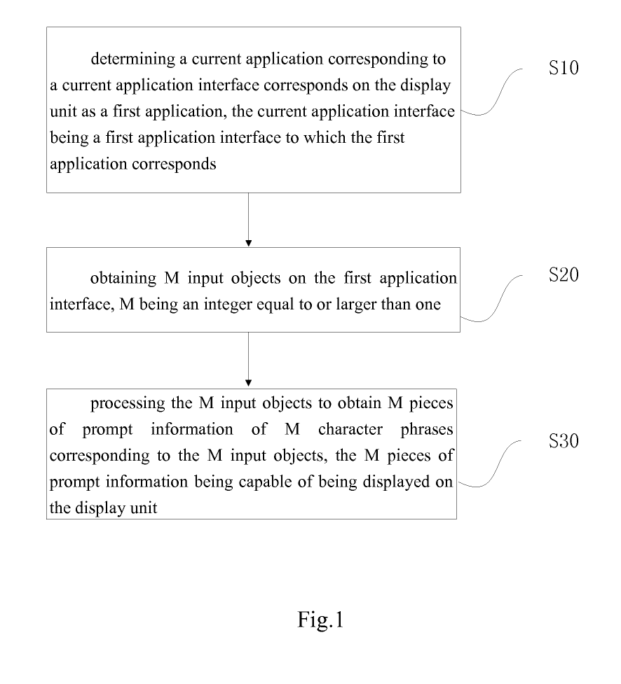

Referring to FIG. 1, the method in the embodiments of the present disclosure comprises the steps of S10, determining a current application corresponding to a current application interface on the display unit as a first application, the current application interface being a first application interface to which the first application corresponds; S20, obtaining M input objects on the first application interface, M being an integer equal to or larger than one; and S30, processing the M input objects to obtain M pieces of prompt information of M character phrases corresponding to the M input objects, the M pieces of prompt information being capable of being displayed on the display unit.

In the embodiments of the present disclosure, after an i-th piece of voice information corresponding to an i-th character phase in the M character phrases is recognized by the electronic apparatus, the electronic apparatus can operate an i-th input object corresponding to the i-th character phase, i is any positive integer less than or equal to M.

In the embodiments of the present disclosure, the M pieces of prompt information specifically are M character phrases having a highlight display effect; or M character phrases having a shadowed display effect; or M character phrases and M pieces of voice prompt information of the M character phrases that can be played in a voice output unit of the electronic apparatus.

For example, in a case that a character phrase is “Next page,” when the electronic apparatus collects, by a voice collecting device, the voice information “Next page” input by the user, it recognizes the voice information, and thereafter generates and executes an operation instruction of “jump to the next page” corresponding to the voice information, and then proceeds to an operation of jumping to the next page.

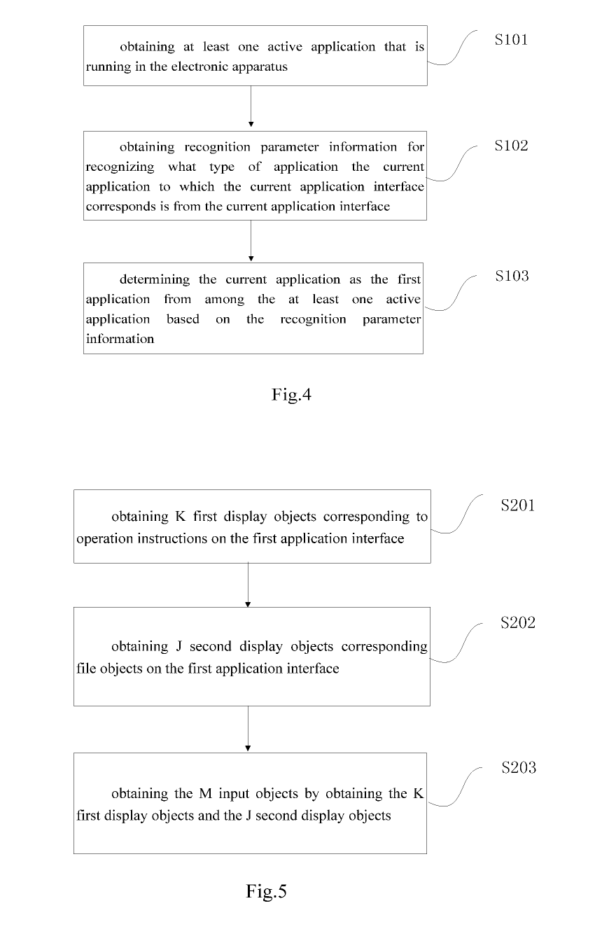

Specifically, referring to FIG. 4, in the embodiments of the present disclosure, step S10 in a specific implementation includes the steps of S 101, obtaining at least one active application that is running in the electronic apparatus; S 102, obtaining recognition parameter information for recognizing what type of application the current application corresponding to the current application interface is from the current application interface; and S 103, determining the current application as the first application from among the at least one active application based on the recognition parameter information.

As for step S103, there are various implementing modes in a specific implementation, and two specific implementing modes will be described in the embodiments of the present disclosure.

First implementing mode when the recognition parameter information specifically is name of the current application, the specific implementing process of step S103 is, based on the name of the current application, determining the current application as the first application corresponding to the name of the current application from among the at least one active application.

Second implementing mode when the recognition parameter information specifically is file information of a file opened in the current application, the specific implementing process of step S103 is, based on the file information, determining the current application as the first application corresponding to the file information from among the at least one active application.

The specific implementing process of step S10 will be described in more detail with a specific example hereinafter.

Assuming that the electronic apparatus specifically is a tablet PC, the tablet PC can access a website having plentiful movie resources by a video player client after the video player client application is installed thereto, when the tablet PC accesses the website via a network, these movie resources can be displayed on a touch display unit of the tablet PC, for the users to browse, select or search. In the embodiments of the present disclosure, the video player client may specifically be a video player application named VIDEOS. Of course, in practical application, it may be Thunder player, Baidu player among others.

Referring to FIG. 2, after the Tablet PC is connected to the network and a video player client is opened, the website can be accessed, the current application interface displayed on the touch display unit includes eight file display objects to which eight movies corresponds, each file display object specifically is an icon plus text display object, that is, each file display object is composed of a thumbnail and text below the thumbnail, eight movies are The Hunger Games, Harry Potter and the Sorcerer's Stone, Lord of the Rings, Star Wars, Iron Man, The Avengers, Star Trek, Twilight, respectively. Of course, in practical application, the eight file display objects to which eight movies correspond may be icon display objects, in this case, there is only image, no text, i.e., each file display object is composed of only a thumbnail, the eight movies are a first icon to which The Hunger Games corresponds, a second icon to which Harry Potter and the Sorcerer's Stone corresponds, a third icon to which Lord of the Rings corresponds, a fourth icon to which Star Wars corresponds, a fifth icon to which Iron Man corresponds, a sixth icon to which The Avengers corresponds, a seventh icon to which Star Trek corresponds, and an eighth icon to which Twilight corresponds. In practical application, the eight file display objects to which the eight movies correspond may probably be text display objects, in this case, there is only text, no image, that is, each file display object is composed of only text, eight movies are the text “The Hunger Games,” the text “Harry Potter and the Sorcerer's Stone,” the text “Lord of the Rings,” the text “Star Wars,” the text “Iron Man,” the text “The Avengers,” the text “Star Trek,” and the text “Twilight.”

Thus, it can be seen that, in the embodiments of the present disclosure, the file display objects may be icon display objects, text display objects, or icon plus text display objects.

Meanwhile, the current application further includes a plurality of operation icons corresponding to operation instructions, when the user has not touch the touch display unit on the tablet PC, the plurality of operation icons are not displayed on the touch display unit yet, when they are being displayed, each operation icon may be an icon display object, that is, each operation icon has only image without text explanation, as shown in FIG. 2, the plurality of operation icons are a Favorites icon, a History icon, a Login icon, a Back icon, a Home icon, a Search icon, an Open icon, and a Next page icon; text “VIDEOS” for indicating name of the current application is also included on the current application interface. Of course, in practical application, each operation icon may be an icon plus the text display object, that is, each operation icon is composed of image and text, in this case, corresponding to the Favorites icon, History icon, Login icon, Back icon, Home icon, Search icon, Open icon, and Next page icon in FIG. 2, the operation icons are the Favorites icon plus the text “Favorites,” the History icon plus the text “History,” the Login icon plus the text “Login,” the Back icon plus the text “Back,” the Home icon plus the text “Home,” the Search icon plus the text “Search,” the Open icon plus the text “Open,” and the Next page icon plus the text “Next page.” In practical application, the plurality of operation icons may be text display objects, in this case, there is only text, no image, that is, each file display object is composed of only text, corresponding to the Favorites icon, History icon, Login icon, Back icon, Home icon, Search icon, Open icon, and Next page icon in FIG. 2, the operation icons are the text “Favorites,” the text “History,” the text “Login,” the text “Back,” the text “Home,” the text “Search,” the text “Open,” and the text “Next page.”

Thus, it can be seen that in the embodiments of the present disclosure, the operation icons may be icon display objects, text display objects, or icon plus text display objects.

The specific implementing process of step S10 is described in detail still using the example in FIG. 2.

First, a step S101 is executed obtaining at least one active application that is running in the electronic apparatus.

Specifically, that is, the tablet PC can obtain a list of at least one active application that is running in the tablet PC by booting and looking up in a task manager, the list includes a video player client, a power management application, a WORD application, and a QQ application.

After step S101, step S102 is executed from the current application interface, obtaining recognition parameter information for recognizing what type of application the current application corresponding to the current application interface is.

Specifically, that is, obtaining the recognition parameter information from the current application interface as shown in FIG. 2, there are two implementing modes in particular, the first case is obtaining the name of the current application, i.e., VIDEOS; the second case is obtaining file information of a file opened in the current application, such as the file information of the movie The Hunger Games includes “name: The Hunger Games,” “attribute: movie file,” “size: 1G,” and “length of time: 95 minutes.”

After step S102, step S103 is executed determining the current application as the first application from among the at least one active application based on the recognition parameter information.

Regarding step S103, there are various modes in a specific implementation, and two specific implementing modes will be described in the embodiments of the present disclosure.

First case when the recognition parameter information specifically is name of the current application, the specific implementing process of step S103 is, determining the current application as the first application corresponding to the name of the current application from among the at least one active application based on the name of the current application.

To be specific, that is, based on the name VIDEOS of the current application in FIG. 2, determining that the current application is a video player terminal from the four applications of a video player client, a power management application, a WORD application, and a QQ application included in the list, in the embodiments of the present disclosure, the video player client is the first application.

Second one when the recognition parameter information specifically is file information of a file opened in the current application, the specific implementing process of step S103 is determining the current application as the first application corresponding to the file information from among the at least one active application based on the file information.

To be specific, that is, based on the attribute information “attribute: movie file” in the file information of the movie The Hunger Games, determining that the current application is a video player client from the four applications of a video player client, a power management application, a WORD application, and a QQ application included in the list. In the embodiments of the present disclosure, the video player client is the first application.

Likewise, in the embodiments of the present disclosure, when the current application interface is a blank document interface of the application WORD, by using “Document 1-Microsoft Word” in the middle of an upper frame thereof, it can be determined that the current application is WORD application.

After step S10, the method in embodiments of the present disclosure proceeds to step S20, that is, obtaining M input objects on the first application interface.

Referring to FIG. 5, in the embodiments of the present disclosure, step S20 specifically includes S201, obtaining K first display objects corresponding to operation instructions on the first application interface; S202, obtaining J second display objects corresponding to file objects on the first application interface, wherein the sum of K and J is M, and K or J is an integer greater than or equal to zero; and S203, obtaining the M input objects by obtaining the K first display objects and the J second display objects.

The specific implementing process of step S20 is described in detail using still the example in step S10.

First, step S201 is executed, that is, obtaining K first display objects corresponding to operation instructions on the first application interface.

To be specific, that is, the tablet PC judges whether there is an icon corresponding to an operation instruction in the frames around the video player application interface, in the embodiments of the present disclosure, no matter the eight operations are icon display objects, text display objects, or icon plus text display objects in particular, the tablet PC will determine the eight operation icons, that is, a Favorites icon, a History icon, a Login icon, a Back icon, a Home icon, a Search icon, an Open icon, and a Next page icon. That is, in this embodiment, K is 8.

After step S201 is executed, it proceeds to step S202 obtaining J second display objects corresponding to file objects on the first application interface, wherein the sum of K and J is M, and K or J is an integer greater than or equal to zero.

To be specific, that is, the Tablet PC obtains the file objects in an area for displaying file objects on the video player terminal application interface, in the embodiment of the present application, no matter that the eight movies are icon display objects, text display objects, or icon plus text display objects in particular, the tablet PC will determine the eight file objects, i.e., eight movies as shown in FIG. 2, which respectively are The Hunger Games, Harry Potter and the Sorcerer's Stone, Lord of the Rings, Star Wars, Iron Man, The Avengers, Star Trek, and Twilight. That is, in the embodiment of the present disclosure, J is 8.

S203, obtaining the M input objects by obtaining the K first display objects and the J second display objects.

To be specific, based on the example in FIG. 2, that is, obtaining sixteen input objects on the video player client interface. In the embodiments of the present disclosure, each of the sixteen input objects itself may be or may not be a voice instruction object.

After step S20 is executed, the embodiments of the present disclosure execute step S30, that is, processing the M input objects to obtain M pieces of prompt information of M character phrases corresponding to the M input objects.

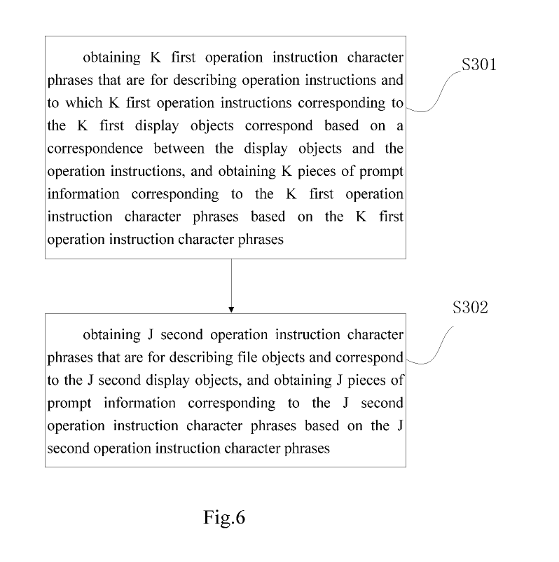

Referring to FIG. 6, in the embodiments of the present disclosure, step S30 specifically includes S301, obtaining K first operation instruction character phrases that are for describing operation instructions and to which K first operation instructions corresponding to the K first display objects correspond based on a correspondence between the display objects and the operation instructions, and obtaining K pieces of prompt information corresponding to the K first operation instruction character phrases based on the K first operation instruction character phrases; and S302, obtaining J second operation instruction character phrases that are for describing file objects and correspond to the J second display objects, and obtaining J pieces of prompt information corresponding to the J second operation instruction character phrases based on the J second operation instruction character phrases.

Step S301 in a specific implementing process specifically includes first, obtaining the K first operation instructions corresponding to the K first display objects based on a correspondence between the display objects and the operation instructions; next, parsing meaning of the K first operation instructions to obtain K strings of text information for describing meaning of operation instructions; then, obtaining the K first operation instruction character phrases corresponding to the K first display objects based on the K strings of text information, wherein each of the K first operation instruction character phrases is different from the other first operation instruction character phrases in the K first operation instruction character phrases; and finally, obtaining K pieces of prompt information corresponding to the K first operation instruction character phrases based on the K first operation instruction character phrases, wherein the K pieces of prompt information specifically are K character phrases having a highlight display effect; or K character phrases having a shadowed display effect; or K character phrases and K pieces of voice prompt information of the K character phrases that can be played in a voice output unit of the electronic apparatus.

In the embodiments of the present disclosure, in order to solve the technical problem that the input mode is not straightforward in the prior art, character length of at least the first one of the K first operation instruction character phrases is less than that of the first string of text information corresponding to the first one of the K first operation instruction character phrases in the K strings of text information. For example, the operation instruction text information corresponding to the icon “Next page” is “jump to the next page,” and the operation instruction character phrase is “next page,” thus it can be seen that “next page” having two words is shorter than “jump to next page” having four words. In this way, when the user makes an input, he/she only needs to input two words, it is not necessary to input four words.

Step S302 in a specific implementing process specifically includes first, obtaining J strings of text information for describing file objects and corresponding to the J second display objects; next, obtaining J second operation instruction character phrases corresponding to the J second display objects based on the J strings of text information, wherein each of the J second operation instruction character phrases is different from the other second operation instruction character phrases in the J second operation instruction character phrases; and finally, obtaining J pieces of prompt information corresponding to the J second operation instruction character phrases based on the J second operation instruction character phrases, wherein the J pieces of prompt information specifically are J character phrases having a highlight display effect; or J character phrases having a shadowed display effect; or J character phrases and J pieces of voice prompt information of the J character phrases that can be played in a voice output unit of the electronic apparatus.

In the embodiments of the present disclosure, in order to solve the technical problem that the input mode is not straightforward in the prior art, length of at least the first one of the J second operation instruction character phrases is less than that of the first string of text information corresponding to the first one of the second operation instruction character phrases in the J strings of text information. For example, the text information of the file object to which the icon of the movie “Harry Potter and the Sorcerer's Stone” corresponds is “Harry Potter and the Sorcerer's Stone,” and the operation instruction character phrase is “Harry Potter,” which is two words and less than “Harry Potter and the Sorcerer's Stone” by four words, so that when the user makes an input, he/she only needs to input two words, it is not necessary to input six words.

In the embodiments of the present disclosure, no limitation is made to the sequence between step S302 and step S301, that is, step S301 can be performed before step S302, or step S302 can be performed before step S301.

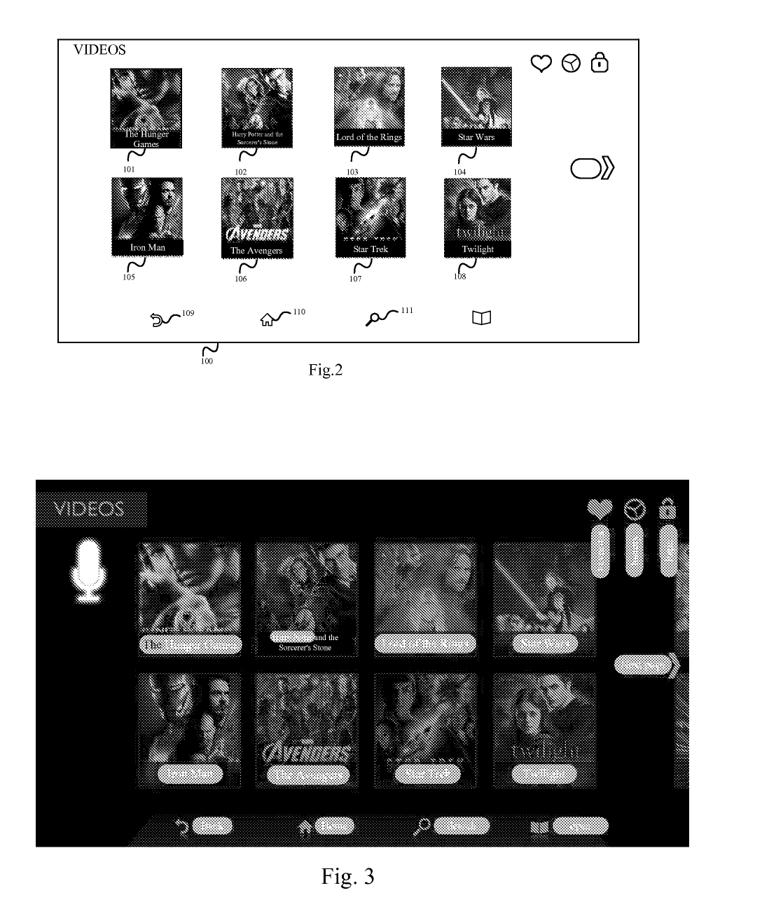

Referring to FIGS. 2 and 3, the implementing process of step S30 will be described in detail below with reference to the above example.

In the embodiments of the present disclosure, no matter the eight operations are icon display objects, text display objects, or icon plus text display objects in particular, the tablet PC will store in a storage unit the correspondence between the display objects and the operation instructions in advance, the correspondence may be a correspondence table in particular as follows.

| Display Object | Operation Instruction |
|---|---|
| Icon of | A collecting instruction for collecting a play object |
| Favorites | specified by the user |
| Icon of History | A viewing instruction for viewing the play history |
| Icon of Login | An login interface generating instruction for generating a |
| | login interface in response to a login operation of the |
| | user |
| Icon of Back | A returning instruction for backing to a previous stage |
| Icon of Home | A homepage returning instruction for backing to the |
| | homepage interface |
| Icon of Search | A searching instruction for initiating a search |
| Icon of Open | An opening instruction for opening a selected file object |
| Icon of Next | A jumping to next page instruction for jumping to the |
| page | next page |

Firstly, based on the above correspondence table, eight operation instructions corresponding to the eight operation icons are obtained, which respectively are a collecting instruction, a viewing instruction, a login interface generating instruction, a returning instruction, a homepage returning instruction, a searching instruction, an opening instruction, and a jumping to next page instruction.

Then, meaning of eight operating instructions are parsed, to obtain eight strings of text information for describing meaning of the operation instructions, which respectively are a collecting instruction for collecting a play object specified by the user, a viewing instruction for viewing the play history, an login interface generating instruction for generating a login interface in response to a login operation of the user, a returning instruction for backing to a previous stage, a homepage returning instruction for backing to the homepage interface, a searching instruction for initiating a search, an opening instruction for opening a selected file object, and a jumping to next page instruction for jumping to the next page.

Then, eight first operation instruction character phrases corresponding to the eight operation icons are obtained based on the eight strings of text information, which respectively are “Favorites,” “History,” “Login,” “Back,” “Home,” “Search,” “Open,” “Next page,” in a specific implementing process, in order to ensure the accuracy of voice instruction, it needs to ensure that each operation instruction character phrase is different from the others. For example, a situation that the Back icon corresponds to “Back,” and the Home icon also corresponds to “Back” is not allowed.

In the eight first operation instruction character phrases, the character phrase “home” has only one word, and the corresponding operation instruction text information is “A home page returning instruction for backing to the homepage interface,” which has more than 10 words, thus it can be seen that, the technical problem that the input mode is not straightforward in the prior art is solved efficiently by means of the embodiments of the present disclosure, and the technical effect of straightforward input is achieved, which improves the degree of user experience.

Finally, eight pieces of prompt information are generated based on the eight first operation instruction character phrases. In the embodiments of the application, the implementing modes of the prompt information are various, three among them will be illustrated herein to introduce.

First case, the prompt information may be eight character phrases having a highlight display effect, to be specific, as shown in FIG. 3, in this case, the eight pieces of prompt information respectively are highlighted text “Favorites,” highlighted text “History,” highlighted text “Login,” highlighted text “Back,” highlighted text “Home,” highlighted text “Search,” highlighted text “Open,” and highlighted text “Next page.”

Second case, the prompt information may be eight character phrases having a shadowed display effect, in this case, the eight pieces of prompt information respectively are shadowed text “Favorites,” shadowed text “History,” shadowed text “Login,” shadowed text “Back,” shadowed text “Home,” shadowed text “Search,” shadowed text “Open,” and shadowed text “Next page.”

Third case, the prompt information may be character phrases and pieces of voice prompt information of the M character phrases that can be played in a voice output unit of the electronic apparatus. In practical application, the sound output unit may be a loudspeaker on the electronic apparatus. In this case, eight pieces of prompt information respectively are: text “Favorites” plus voice “Favorites,” text “History” plus voice “History,” text “Login” plus voice “Login,” text “Back” plus voice “Back,” text “Home” plus voice “Home,” text “Search” plus voice “Search,” text “Open” plus voice “Open,” and text “Next page” plus voice “Next page.”

Please referring to FIGS. 2 and 3, a specific implementing process of step S302 is as follows.

In the embodiments of the present disclosure, no matter the eight movies are icon display objects or icon plus text display objects in particular, first of all, an operation of obtaining eight strings of text information of the eight movies should be carried out so as to obtain the eight strings of text information of the eight movies, which respectively are “The Hunger Games,” “Harry Potter and the Sorcerer's Stone,” “Lord of the Rings,” “Star Wars,” “Iron Man,” “The Avengers,” “Star Trek,” and “Twilight.”

Thereafter, the eight strings of text information are processed, to obtain eight character phrases corresponding to the eight movies, that is, “The Hunger Games,” “Harry Potter,” “Lord of the Rings,” “Star Wars,” “Iron Man,” “the Avengers,” “Star Trek,” and “Twilight.” In an implementing process, in order to ensure the accuracy of voice instruction, it needs to ensure that each operation instruction character phrase is different from the others. For example, when the eight movies includes “Harry Potter and the Sorcerer's Stone” and “Harry Potter and the Chamber of Secrets,” it is not allowed that both “Harry Potter and the Sorcerer's Stone” and “Harry Potter and the Chamber of Secrets” correspond to the text phrase “Harry Potter,” and it should be that “Harry Potter and the Sorcerer's Stone” corresponds to “Sorcerer's Stone” and “Harry Potter and the Chamber of Secrets” corresponds to “Chamber of Secrets.”

Finally, eight pieces of prompt information are generated based on the eight characters phrases of the eight movies. In the embodiments of the present disclosure application, the implementing modes of the prompt information are multiple, three among them will be illustrated herein to introduce.

First implementing mode the prompt information may be eight character phrases having a highlight display effect, to be specific, as shown in FIG. 3, in this case, the eight pieces of prompt information to which the eight movies correspond respectively are highlighted text “The Hunger Games,” highlighted text “Harry Potter,” highlighted text “Lord of the Rings,” highlighted text “Star Wars,” highlighted text “Iron Man,” highlighted text “The Avengers,” highlighted text “Star Trek,” and highlighted text “Twilight.”

Second implementing mode, the prompt information may be eight character phrases having a shadowed display effect, in this case, the eight pieces of prompt information to which the eight movies correspond respectively are: shadowed text “The Hunger Games,” shadowed text “Harry Potter,” shadowed text “Lord of the Rings,” shadowed text “Star Wars,” shadowed text “Iron Man,” shadowed text “The Avengers,” shadowed text “Star Trek,” and shadowed text “Twilight.”

Third implementing mode, the prompt information may be character phrases and pieces of voice prompt information of the character phrases that can be played in a voice output unit of the electronic apparatus. In practical application, the sound output unit may be a loudspeaker on the electronic apparatus. In this case, the eight pieces of prompt information to which the eight movies correspond respectively are: text “The Hunger Games” plus voice “The Hunger Games,” text “Harry Potter” plus voice “Harry Potter,” text “Lord of the Rings” plus voice “Lord of the Rings,” text “Star Wars” plus voice “Star Wars,” text “Iron Man” plus voice “Iron Man,” text “The Avengers” plus voice “The Avengers,” text “Star Trek” plus voice “Star Trek,” and text “Twilight” plus voice “Twilight.”

Thus, it can be seen that, the icon of the movie “Harry Potter and the Sorcerer's Stone” corresponds to the file object text information “Harry Potter and the Sorcerer's Stone,” and corresponds to the operation instruction character phrase “Harry Potter,” which is two words, four less than “Harry Potter and the Sorcerer's Stone.” In this way, when the user makes an input, he/she only needs to input two words instead of six words, it is not necessary to input four words. Accordingly, the technical problem that the input mode is not straightforward in the prior art is solved, and the technical effect of adopting straightforward input mode and improving user experience are achieved.

In the embodiments of the present disclosure, after the execution of step S30 is completed, the tablet PC can accurately respond to the user's voice instruction.

For example, the user can precisely input the voice “Home” based on the text phrase prompting in FIG. 3, i.e., the highlighted text “Home,” the tablet PC will collect the voice information “home” by the microphone, make voice recognition, generate and execute a homepage return instruction, and thereby control the current displayer interface of the tablet PC to back to the homepage of the video client application.

Again, for example, the user can precisely input the voice “Harry Potter” based on the text phrase prompting in FIG. 3, i.e. the highlighted text “Harry Potter,” the tablet PC will collect the voice information “Harry Potter” by the microphone, make voice recognition, and select the determined movie “Harry Potter and the Sorcerer's Stone” from the eight movies. If the user continues to accurately input the voice “Open” according to the highlighted text phrase “Open,” the tablet PC will collect the voice information “Open,” generate and execute the opening instruction, and thereby play the movie “Harry Potter and the Sorcerer's Stone.”

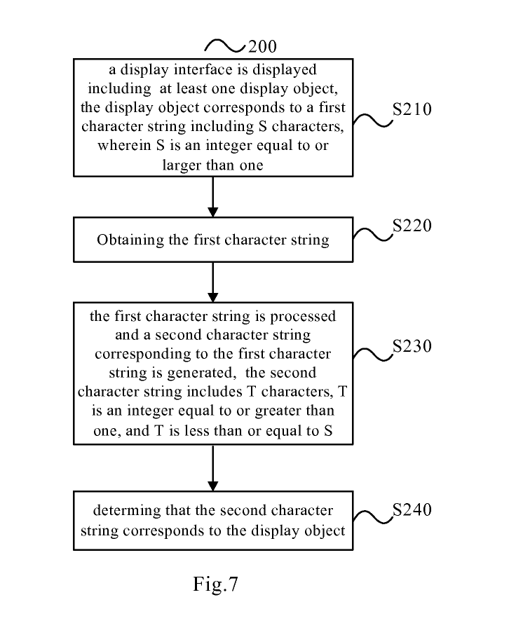

A method for providing software operation assistance by way of voice according to embodiments of the present disclosure will be described hereinafter with reference to FIG. 7. FIG. 7 shows a flowchart of a processing method 200 for assisting in input by way of voice according to an embodiment of the present disclosure.

As shown in FIG. 7, in step S210, a display interface is displayed, at least one display object is displayed within the display interface, the display object corresponds to a first character string including S characters, wherein S is an integer equal to or larger than one. In one embodiment, the display object included within the display interface per se can be taken as the first character string, for instance, the display objects 109, 110, and 111 displayed on the display interface in FIG. 2 correspond to “Back,” “Home,” and “Search”; also, name of the display objects may be taken as the first character string, such as the names to which posters or icons correspond, for instance, the names “The Hunger Games,” “Harry Potter and the Sorcerer's Stone,” “Lord of the Rings,” “Star Wars,” “Iron Man,” “The Avengers,” “Star Trek,” and “Twilight” corresponding to the display objects 101, 102, 103, 104, 105, 106, 107, and 108 displayed on the display interface in FIG. 2.

Next, in step S220, the first character string including S characters is obtained, for instance, on the display interface shown in FIG. 2, the first character string “Harry Potter and the Sorcerer's Stone” to which the display object 102 corresponds is obtained.

Then in step S230, the first character string is processed and a second character string corresponding to the first character string is generated, wherein the second character string includes T characters, T is an integer equal to or greater than one, and T is less than or equal to S.

The processing the first character string and generating a second character string corresponding to the first character string executed in step S230 may include processing the first character string according to a predefined rule and generating the second character string. To be specific, the predefined rule is as follows, when a number of characters of the first character string is more than a preset number N, determining that the second character string is the first to N characters of the first character string; when the number of characters of the first character string is less than or equal to the preset number N, determining that the second character string is the S characters of the first character string, N being a positive integer. For instance, on the display interface as shown in FIG. 2, N may be preset as 2, then the first character string “Harry Potter and the Sorcerer's Stone” can be processed to generate the second character string “Harry Potter” in accordance with this predefined rule.

Alternatively, when processing the first character string and generating a second character string corresponding to the first character string is executed in step S230, the predefined rule may be also extracting a keyword in the first character string and determining that the second character string is characters to which the keyword of the first character string corresponds. For instance, on the display interface as shown in FIG. 2, the keyword of the first character string “Harry Potter and the Sorcerer's Stone” may be “Sorcerer's Stone,” then the first character string “Harry Potter and the Sorcerer's Stone” can be processed to generate the second character string “Sorcerer's Stone” in accordance with this predefined rule.

Last, in step S240, it is determined that the second character string corresponds to the display object. It can be known from the above description that the second character string corresponds to the first character string, while the first character string corresponds to a display object on the display interface, thus, a correspondence between the second character string and the display object can be determined in this step. The second character is for triggering the display object corresponding to the second character string when a voice input is received and voice matching conducted based on the second character string succeeds. For instance, on the display interface as shown in FIG. 2, it can be determined that the second character string “Sorcerer's Stone” corresponds to the display object 102, so when the voice input “Sorcerer's Stone” of the user is received and it matches the second character string “Sorcerer's Stone” successfully, the display object 102 corresponding to the second character string “Sorcerer's Stone” is triggered.

Since the second character, string generated in accordance with the aforesaid rules corresponds to the first character string, and it is shorter than the first character string corresponding thereto, thus, time required for recognizing the voice instruction is shortened, and efficiency of voice instruction recognition is enhanced.

In addition, the processing method for assisting in input by way of voice according to the present disclosure may further include a step of obtaining a triggering instruction and prompting the second character string in response to the triggering instruction. The mode of prompting the second character string may be by way of various forms such as graphic, voice, text etc. For instance, in the graphic prompting mode, a graphic may be displayed at a corresponding position of the display object, prompting the user to make voice input, for instance, an arrow toward left etc. may be displayed in neighborhood of the display object “Back”; in the voice prompting mode, the second character string to which the display object corresponds may be prompted by voice, such as a position where a finger resides may be detected, and voice information is prompted with regard to the display object near the position of the finger; and in the text prompting mode, the second character string may be displayed at a corresponding position of a display object on the display interface.

In another embodiment, the processing method for assisting in input by way of voice according to the present disclosure may further include a step of obtaining a triggering instruction for activating a voice recognition function before step S220 of obtaining the first character string, and a step of displaying the second character string at a corresponding position of the display object on the display interface in response to the triggering instruction after step S240 of determining that the second character string corresponds to the display object. For instance, before obtaining the first character string, a triggering instruction may be obtained through activating the voice input by a user keystroke; then, after determining that the second character string corresponds to the display object, the display interface has a corresponding display change accordingly to prompt the second character string.

In another embodiment, the processing method for assisting in input by way of voice according to the present disclosure may further include a step of obtaining a triggering instruction for activating a voice recognition function after step S240 of determining that the second character string corresponds to the display object, and displaying the second character string at a corresponding position of the display object on the display interface in response to the triggering instruction. For instance, after determining that the second character string corresponds to the display object, a triggering instruction may be obtained through activating the voice input by a user keystroke; then, the display interface has a corresponding display change accordingly to prompt the second character string.

In an embodiment, when the second character string is displayed using the text prompting mode, the T characters included in the second character string may be indicated and highlighted in the first character string displayed on the display interface. The second character string may indicated and highlighted in the first character string displayed on the display interface in various modes, for instance, a visible marker may be used to distinguish from other graphics or texts on the interface, that is, the visible marker can indicate which text can be taken as a voice instruction that can be executed by a voice input. Various markers may be used as a visible marker, such as peculiar changes to font formats and styles, like double underline, changing foreground color, changing background color, changing fonts, and changing font size etc. For example, on the display interface as shown in FIG. 8, the mode of changing background color is adopted to highlight the second character string “Harry” in the first character string “Harry Potter and the Sorcerer's Stone.”

In addition, when a plurality of display objects are included on the display interface, each of the plurality of display objects corresponds to one first character string, obtaining the first character string may include obtaining first character strings corresponding to each of the display objects to form a first character string library including a plurality of first character strings. For instance, on the display interface as shown in FIG. 2, a plurality of first character string “The Hunger Games,” “Harry Potter and the Sorcerer's Stone,” “Lord of the Rings,” “Star Wars,” “Iron Man,” “The Avengers,” “Star Trek,” “Twilight,” “Back,” “Home,” and “Search” corresponding to a plurality of display objects 101, 102, 103, 104, 105, 106, 107, 108, 109, 110, and 111 are obtained to form the first character string library.

At this time, processing the first character string and generating a second character string corresponding to the first character string may include processing each of the plurality of first character strings and generating second character strings corresponding to each of the first character strings, to form a second character string library including a plurality of second character strings. To be specific, the plurality of first character string may be processed in accordance with a predefined rule to generate a plurality of second character strings, which form a second character string library, and the plurality of second character strings in the second character string library are different form each other. The predefined rule may be as follows when the number of characters of the first character string is more than a preset number N, determining that the second character string is the first to N characters of the first character string; when the number of characters of the first character string is less than or equal to the preset number N, determining that the second character string is the S characters of the first character string, N being a positive integer. For instance, N can be preset as one, then the plurality of first characters string “The Hunger Games,” “Harry Potter and the Sorcerer's Stone,” “Lord of the Rings,” “Star Wars,” “Iron Man,” “The Avengers,” “Star Trek,” “Twilight,” “Back,” “Home,” and “Search” in the first character string library can be processed to generate a second character string library including a plurality of second character strings “Hunger,” “Harry,” “Ring,” “Star,” “Iron,” “Avengers,” “Trek,” “Twilight,” “Back,” “Home,” and “Search.”

Alternatively, the predefined rule may be extracting a keyword in the first character string and determining that the second character string is characters to which the keyword of the first character string corresponds as described above. For instance, on the display interface as shown in FIG. 2, the keywords of the plurality of first characters “The Hunger Games,” “Harry Potter and the Sorcerer's Stone,” “Lord of the Rings,” “Star Wars,” “Iron Man,” “The Avengers,” “Star Trek,” “Twilight,” “Back,” “Home,” and “Search” in the first character string library may be “Games,” “Sorcerer's Stone,” “Lord of the Rings,” “Wars,” “Iron Man,” “Avengers,” “Trek,” “Twilight,” “Back,” “Home,” and “Search,” in accordance with this predefined rule, the plurality of first character strings in the first character string library can be processed to generate a second character string library including a plurality of second character strings “Games,” “Sorcerer's Stone,” “Lord of the Rings,” “Wars,” “Iron Man,” “Avengers,” “Trek,” “Twilight,” “Back,” “Home,” and “Search.”

Thereafter, a correspondence between the plurality of second character strings in the second character string library and the plurality of display objects on the display interface is determined. It can be known from the above description that since the plurality of second character strings correspond to the plurality of first character strings one to one, while the plurality of first character strings correspond to the plurality of display objects on the display interface one to one, thus a one-to-one correspondence between the plurality of second character strings and the plurality of display objects can be determined. For instance, on the display interface as shown in FIG. 2, it can be determined that the plurality of second character strings “Hunger,” “Harry,” “Ring,” “Star,” “Iron,” “Avengers,” “Trek,” “Twilight,” “Back,” “Home,” and “Search” as mentioned above respectively correspond to the plurality of display objects 101, 102, 103, 104, 105, 106, 107, 108, 109, 110, and 111 one to one.

In this case, the second character string library is used as a voice matching library for voice matching, a display object is triggered when a voice input is received and voice matching conducted based on the second character string in the second character string library succeeds. To be specific, when a voice instruction inputted by a user is obtained, after content of the voice instruction inputted by the user is recognized, a corresponding second character can be searched out from string in the second character string library, then the display object corresponding to the second character string that has been searched out is triggered immediately; in another embodiment, after a voice instruction inputted by a user is obtained, the voice of the user can be matched item by item to the voice of a plurality of second character strings in the second character string library, so as to recognize a specific second character string to which the instruction of the user corresponds, and trigger a display object corresponding to the specific second character string.

In addition, when a plurality of display objects are included on the display interface, the step of prompting the second character string may include prompting a plurality of second character strings in the second character string library by various modes such as graphic, voice, text etc. as mentioned above. In an embodiment, when the text prompting mode is used to display the plurality of second character strings in the second character string library, the characters included in the second character strings in the second character string library may be indicated and highlighted in the corresponding first character strings displayed on the display interface. For instance, on the display interface as shown in FIG. 8, the characters “Hunger,” “Harry,” “Lord,” “Star,” “Iron,” “Avengers,” “Trek,” “Twilight,” “Back,” “Home,” and “Search” of the corresponding second character strings are highlighted on the plurality of first character strings “The Hunger Games,” “Harry Potter and the Sorcerer's Stone,” “Lord of the Rings,” “Star Wars,” “Iron Man,” “The Avengers,” “Star Trek,” “Twilight,” “Back,” “Home,” and “Search” in a manner of changing background color.

Since each of the second character strings in the second character string library is different from the others, and corresponds to each of the first character strings in the first character string library one to one, and each of the second character strings in the second character string library is shorter than a corresponding first character string in the first character string library, thus, time required for recognizing the voice instruction is shortened, and efficiency of voice instruction recognition is enhanced.

It should be noted that, the steps in the method described with reference to FIG. 7 could be implemented in combination with the method described with reference to FIG. 1. For instance, step S30 in FIG. 1 can be implemented by using the method shown in FIG. 7. To be specific, processing the M input objects to obtain M pieces of prompt information of M character phrases corresponding to the M input objects (S30) may include obtaining a first character string corresponding to one of the M input objects and including S characters (S220 in FIG. 7); processing the first character string and generating a second character string corresponding to the first character string, wherein the second character string includes T characters, S and T are an integer equal to or greater than one, and T is less than S (S230 in FIG. 7); and determining that the second character string corresponds to one of the input objects, the second character string being for triggering an corresponding input object when a voice input is received and voice matching conducted based on the second character string succeeds (S240 in FIG. 7). As for the respective steps in FIG. 7 involved herein, please see the above description with reference to FIG. 7. In addition, obtaining a triggering instruction and displaying in response to the triggering instruction described with reference to FIG. 7 may be incorporated into the method of FIG. 1.

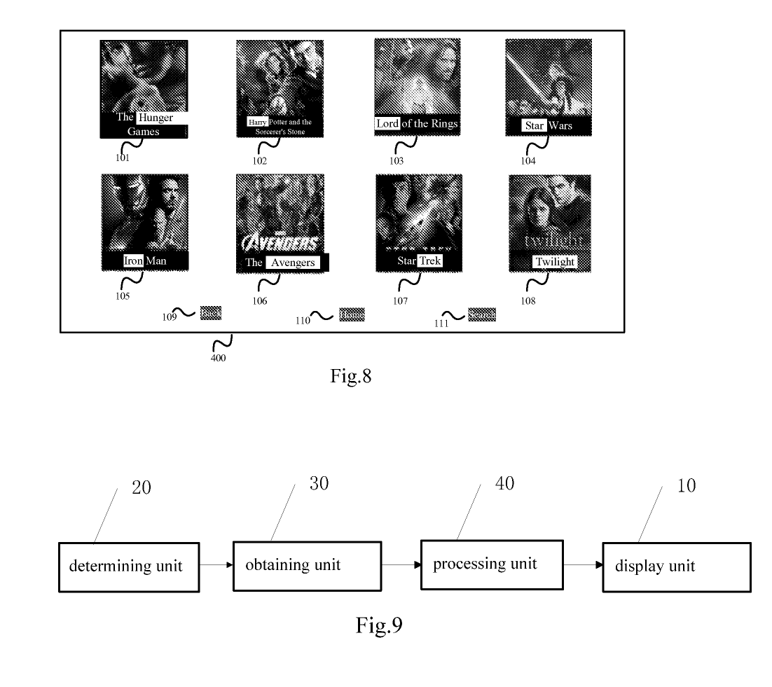

Referring to FIG. 9, based on the same inventive concepts as the method in the embodiments of the present disclosure, the embodiments thereof also provide an electronic apparatus including a display unit 10, the electronic device further including a determining unit 20 for determining a current application corresponding to a current application interface on the display unit as a first application, the current application interface being a first application interface to which the first application corresponds; an obtaining unit 30 for obtaining M input objects on the first application interface, M being an integer equal to or larger than one; and a processing unit 40 for processing the M input objects to obtain M pieces of prompt information of M character phrases corresponding to the M input objects, the M pieces of prompt information being capable of being displayed on the display unit, wherein after an i-th piece of voice information to which an i-th character phase in the M character phrases corresponds is recognized by the electronic apparatus, the electronic apparatus can operate an i-th input object corresponding to the i-th character phase, the i is any positive integer less than or equal to M.

In the embodiments of the present disclosure, the M pieces of prompt information specifically are M character phrases having a highlight display effect; or M character phrases having a shadowed display effect; or M character phrases and M pieces of voice prompt information of the M character phrases that can be played in a voice output unit of the electronic apparatus.

In the embodiments of present disclosure, the determining unit 20 specifically includes a first obtaining sub-unit for obtaining at least one active application that is running in the electronic apparatus; a second obtaining sub-unit for obtaining recognition parameter information for recognizing what type of application the current application corresponding to the current application interface is from the current application interface; and determining sub-unit for determining the current application as the first application from among the at least one active application based on the recognition parameter information.

In the present embodiment, the recognition parameter information specifically is name of the current application, or file information of a file opened in the current application.

When the recognition parameter information specifically is name of the current application, the second obtaining sub-unit specifically is a program name determining sub-unit, the program name determining sub-unit determines the current application as the first application corresponding to the name of the current application from among the at least one active application based on the name of the current application.

when the recognition parameter information specifically is file information of a file opened in the current application, the second obtaining sub-unit specifically is a file name determining sub-unit, the file name determining sub-unit determines the current application as the first application corresponding to the file information from among the at least one active application based on the file information.

Further, in the embodiments of the application, the obtaining unit 30 specifically includes a third obtaining sub-unit for obtaining K first display objects corresponding to operation instructions on the first application interface; a fourth obtaining sub-unit for obtaining J second display objects corresponding to file objects on the first application interface, wherein the sum of K and J is M, and K or J is an integer greater than or equal to zero; and a fifth obtaining sub-unit for obtaining the M input objects by obtaining the K first display objects and the J second display objects.

Further, in the embodiments of the present disclosure, the processing unit 40 specifically includes a first processing sub-unit for, based on a correspondence between the display objects and the operation instructions, obtaining K first operation instruction character phrases that are for describing operation instructions and to which K first operation instructions corresponding to the K first display objects corresponds, and for obtaining K pieces of prompt information corresponding to the K first operation instruction character phrases based on the K first operation instruction character phrases; and a second processing sub-unit for obtaining J second operation instruction character phrases that are for describing file objects and correspond to the J second display objects, and for obtaining J pieces of prompt information corresponding to the J second operation instruction character phrases based on the J second operation instruction character phrases.

In the embodiments of the present disclosure, the first processing sub-unit specifically includes a first obtaining module for obtaining the K first operation instructions corresponding to the K first display objects based on a correspondence between the display objects and the operation instructions; a parsing module for parsing meaning of the K first operation instructions to obtain K strings of text information for describing meaning of operation instructions; a second obtaining module for obtaining the K first operation instruction character phrases corresponding to the K first display objects based on the K strings of text information, wherein each of the K first operation instruction character phrases is different from the other first operation instruction character phrases in the K first operation instruction character phrases, furthermore, character length of at least the first one of the K first operation instruction character phrases is less than that of the first string of text information corresponding to the first one of the K first operation instruction character phrases in the K strings of text information; and a third obtaining module for obtaining K pieces of prompt information corresponding to the K first operation instruction character phrases based on the K first operation instruction character phrases.

In the embodiments of the present disclosure, the second processing sub-unit specifically includes a fourth obtaining module for obtaining J strings of text information for describing file objects and corresponding to the J second display objects; a fifth obtaining module for obtaining J second operation instruction character phrases corresponding to the J second display objects based on the J strings of text information, wherein each of the J second operation instruction character phrases is different from the other second operation instruction character phrases in the J second operation instruction character phrases; and a sixth obtaining module for obtaining J pieces of prompt information corresponding to the J second operation instruction character phrases based on the J second operation instruction character phrases.

Through one or more of the technical solutions provided by the embodiments of the present disclosure, at least the following technical effects can be achieved.

Since, by means of the technical solutions of the embodiments of the present disclosure, character phrases corresponding to an input object can be finally displayed on the display unit of the electronic apparatus, such as, with respect to a “Back” icon on a player interface corresponding to a video player client, after the technical solutions of the present disclosure are implemented, besides that the icon is still displayed on the player interface, a corresponding text phrase, such as “Back,” will be displayed at an upper, lower, left, or right side of the icon, which facilitates the user making voice input accurately. Therefore the technical problem as follows is solved when the user inputs a voice instruction different from the fixed voice instruction due to incapability of remembering the fixed voice instruction, the electronic devices cannot respond or will mistakenly respond; and further the technical effect as follows is solved the user is prompted accurately through the character phrases, and a proper response can be made when the user inputs a voice instruction is achieved.

Since the technical solutions according to the embodiments of the present disclosure can output character phrases for a file object, and the character phrases are determined under the premise of being different from the character phrases of other file objects, a principle of simplification is adopted, such as, with respect to the movie “Harry Potter and the Sorcerer's Stone,” the corresponding text phrase is “Harry Potter,” which makes the electronic apparatus be capable of determining the movie “Harry Potter and the Sorcerer Stone” when collecting the voice information “Harry Potter,” and thereby solves the technical problem that the input mode is not straightforward in the prior art, and further achieves the technical effect of adopting straightforward input mode and improving user experience.

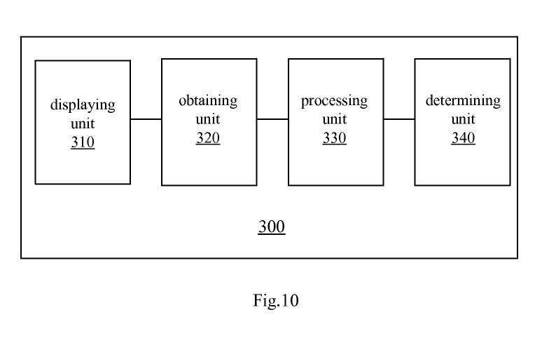

A terminal apparatus 300 according to the present disclosure will be described hereinafter with reference to FIG. 10. FIG. 10 shows an exemplary structural block diagram of the terminal apparatus 300 according to the embodiments of the present disclosure. As shown in FIG. 10, the terminal apparatus 300 includes a displaying unit 310, an obtaining unit 320, a processing unit 330, and a determining unit 340.

To be specific, the displaying unit 310 is for displaying a display interface within which at least one display object is included, the display object corresponds to a first character string including S characters. In particular, the display objects included within the display interface per se can be taken as the first character string, also, name of the display objects may be taken as the first character string, such as names to which posters, or icons correspond.

The obtaining unit 320 is for obtaining the first character string. For instance, on the display interface as shown in FIG. 2, the obtaining unit 320 obtains the first character string “Harry Potter and the Sorcerer's Stone” to which the display object 102 corresponds.

The processing unit 330 is for processing the first character string to generate a second character string corresponding to the first character string, wherein the second character string includes T characters, S and T are an integer equal to or greater than one, and T is less than or equal to S.

To be more specific, the processing unit may process the first character string and generating the second character string according to a predefined rule. In an embodiment, the predefined rule is as follows when the number of characters of the first character string is more than a preset number N, determining that the second character string is the first to N characters of the first character string; when the number of characters of the first character string is less than or equal to the preset number N, determining that the second character string is the S characters of the first character string, N being a positive integer. For instance, on the display interface as shown in FIG. 2, N may be preset as 2, then the processing unit 330 can process the first character string “Harry Potter and the Sorcerer's Stone” and generate the second character string “Harry Potter” according to this predefined rule.

In another embodiment, when the processing unit 330 processes the first character string and generates a second character string corresponding to the first character string, the predefined rule may be also extracting a keyword in the first character string and determining that the second character string is characters to which the keyword of the first character string corresponds. For instance, on the display interface as shown in FIG. 2, the keyword of the first character string “Harry Potter and the Sorcerer's Stone” may be “Sorcerer's Stone,” then the processing unit 330 can process the first character string “Harry Potter and the Sorcerer's Stone” and generate the second character string “Sorcerer's Stone” according to this predefined rule.

The determining unit 340 determines that the second character string corresponds to the display object. Since the second character string corresponds to the first character string, and the first character string corresponds to a display object on the display interface, thus, the determining unit 340 can determine a correspondence between the second character string and the display object. The second character is for triggering a corresponding display object when a voice input is received and voice matching conducted based on the second character string succeeds. For instance, on the display interface as shown in FIG. 2, the determining unit 340 can determine that the second character string “Sorcerer's Stone” corresponds to the display object 102, so when the voice input “Sorcerer's Stone” of the user is received and it matches the second character string “Sorcerer's Stone” successfully, the display object 102 corresponding to the second character string “Sorcerer's Stone” is triggered.

In an embodiment, the terminal apparatus 300 according to an embodiment of the present disclosure may further include a prompt displaying unit for displaying the second character string at a position of a corresponding display object on the display interface. To be more specific, the prompt displaying unit may prompt the second character string by various modes such as graphic, voice, text etc. as mentioned above. In the text prompting mode, the T characters included in the second character strings can be indicated and highlighted in the corresponding first character string displayed on the display interface by the prompt displaying unit. For instance, on the display interface 400 as shown in FIG. 8, the second character string “Harry” is highlighted in the first character string “Harry Potter and the Sorcerer's Stone” in a manner of changing background color.

In another embodiment, the terminal apparatus 300 according to an embodiment of the present disclosure may further include a voice initiating unit for obtaining a triggering instruction for activating a voice recognition function before the obtaining unit 320 obtains the first character string; and a prompt displaying unit for displaying the second character string at a position of a corresponding display object on the display interface after the determining unit 340 determines that the second character string corresponds to the display object. In another embodiment, the voice activating unit of the terminal apparatus 300 may obtains a triggering instruction for activating a voice recognition function after the determining unit 340 determines that the second character string corresponds to the display object; and the prompt displaying unit of the terminal apparatus 300 may display the second character string at a position of a corresponding display object on the display interface in response to the triggering instruction.

Since the second character, string generated according to the aforesaid rules corresponds to the first character string, and it is shorter than the first character string corresponding thereto, thus, time required for recognizing the voice instruction is shortened, and efficiency of voice instruction recognition is enhanced.

In addition, when a plurality of display objects are included on the display interface, each of the plurality of display objects corresponds to one first character string, the obtaining unit 310 may further obtain first character strings corresponding to each of the input objects to form a first character string library including a plurality of first character strings; the processing unit 330 may further process each of the plurality of first character strings and generating second character strings corresponding to each of the first character strings, so as to form a second character string library including a plurality of second character strings.

In addition, the processing unit 330 can process the plurality of first character strings according to a predefined rule to generate a plurality of second character strings, which form a second character string library. To be specific, the predefined rule may be as follows when the number of characters of the first character string is more than a preset number N, determining that the second character string is the first to N characters of the first character string; when the number of characters of the first character string is less than or equal to the preset number N, determining that the second character string is the S characters of the first character string, N being a positive integer. Alternatively, the predefined rule may be extracting a keyword in the first character string and determining that the second character string is characters corresponding to the keyword of the first character string.

Each of the second character strings in the second character string library is different from the others, and the second character string library is used as a voice matching library for voice matching. A display object is triggered when a voice input is received and voice matching conducted based on the second character string in the second character string library succeeds. To be specific, when a voice instruction inputted by a user is obtained, after content of the voice instruction inputted by the user is recognized, a corresponding second character string in the second character string library can be searched out, then the display object corresponding to the second character string that has been searched out is triggered immediately; in another embodiment, after a voice instruction inputted by a user is obtained, the voice of the user can be matched item by item to the voice of a plurality of second character strings in the second character string library, so as to recognize a specific second character string to which the instruction of the user corresponds, and trigger a display object corresponding to the specific second character string.

In addition, when a plurality of display objects are included on the display interface, the prompt displaying unit can further prompt the second character string by various modes such as graphic, voice, text etc. as mentioned above. In an embodiment, when the text prompting mode is used for displaying the plurality of second character strings in the second character string library, the characters included in the second character strings can be indicated and highlighted in the second character string library in the corresponding first character string displayed on the display interface by the prompt displaying unit. For instance, on the display interface as shown in FIG. 8, in a manner of changing background color, the characters “Hunger,” “Harry,” “Lord,” “Star,” “Iron,” “The Avengers,” “Trek,” “Twilight,” “Back,” “Home,” and “Search” of the corresponding second character strings are highlighted on the plurality of first character strings “The Hunger Games,” “Harry Potter and the Sorcerer's Stone,” “Lord of the Rings,” “Star Wars,” “Iron Man,” “The Avengers,” “Star Trek,” “Twilight,” “Back,” “Home,” and “Search.”

Since each of the second character strings in the second character string library is different from the others, and corresponds to each of the first character strings in the first character string library one to one, and each of the second character strings in the second character string library is shorter than a corresponding first character string in the first character string library, thus, time required for recognizing the voice instruction is shortened, and efficiency of voice instruction recognition is enhanced.

It should be noted that, the terminal apparatus described with reference to FIG. 10 could be implemented in combination with the electronic apparatus described with reference to FIG. 9. For instance, the processing unit 40 in FIG. 9 can be implemented by using the component units shown in FIG. 10. To be specific, the processing unit 40 in FIG. 9 may include a first sub-unit (i.e., the obtaining unit 320 in FIG. 10) for obtaining a first character string corresponding to one of the M input objects and including S characters; a second sub-unit (i.e., the processing unit 330 in FIG. 10) for processing the first character string and generating a second character string corresponding to the first character string, the second character string including T characters, S and T being an integer equal to or greater than one, and T being less than or equal to S; and a third sub-unit (i.e., the determining unit 340 in FIG. 10) for determining that the second character string corresponds to one of the input objects, the second character string being for triggering an corresponding input object when a voice input is received and voice matching conducted based on the second character string succeeds. As for the respective units in FIG. 10 involved herein, please see the above description with reference to FIG. 10. In addition, the voice activating unit and the prompt displaying unit described with reference to FIG. 10 may be incorporated into the electronic apparatus in FIG. 9.

Those skilled in the art should understand that, the embodiments of the present disclosure can be provided as a method, a system, or a computer program product. Therefore, the present disclosure can adopt forms of a full hardware embodiment, a full software embodiment, or an embodiment combining software and hardware aspects. In addition, the present disclosure can adopt forms of a computer program product implemented on one or more computer usable storage mediums (including, but not limited to, magnetic disk storage, CD-ROM, optical memory, or the like) including computer usable program codes.

The present disclosure is described by referring to flow charts and/or block diagrams of method, apparatus (system), and computer program product according to the embodiments of the present disclosure. It should be understood that each flow and/or block in the flow charts and/or block diagrams and the combination of the flow and/or block in the flow charts and/or block diagrams could be implemented by computer program instructions. These computer program instructions can be provided to processors of a general purpose computer, a dedicated computer, an embedded processor or other programmable data processing apparatus to generate a machine, so that a device for implementing functions specified in one or more flows of the flow charts and/or one or more blocks of the block diagrams is generated by the instructions executed by the processors of the computer or other programmable data processing apparatus.

These computer program instructions can also be stored in computer readable storage which is able to direct the computer or other programmable data processing apparatus to operate in specific manners, so that the instructions stored in the computer readable storage generate manufactured articles including commander equipment, which implements functions specified by one or more flows in the flow charts and/or one or more blocks in the block diagrams.

These computer program instructions can be loaded to computer or other programmable data processing apparatus, so that a series of operation steps are executed on the computer or other programmable apparatus to generate computer implemented process, so that the instructions executed on the computer or other programmable apparatus provide steps for implementing functions specified in one or more flows of the flow charts and/or one or more blocks of the block diagrams.

Although the preferred embodiments of the present disclosure have been described, those skilled in the art can make additional changes and modifications to these embodiments once learning the basic inventive concepts thereof. Therefore, the appended claims are intended to be interpreted as including the preferred embodiments as well as all changes and modifications that fall into the scope of the present disclosure.

Obviously, those skilled in the art can make various modifications and variations to the present disclosure without departing from the spirit and scope thereof. Thus, if these modifications and variations of the present disclosure are within the scope of the claims of the invention as well as their equivalents, the present disclosure is also intended to include these modifications and variations.

What is claimed is:

1. An information processing method applied to an electronic apparatus including a display unit, the method comprising:
determining a current application corresponding to a current application interface on the display unit as a first application, the current application interface being a first application interface to which the first application corresponds;
obtaining M input objects on the first application interface, M being an integer equal to or larger than one; and
processing the M input objects to obtain M pieces of prompt information of M character phrases corresponding to the M input objects, the M pieces of prompt information being capable of being displayed on the display unit, wherein after an i-th piece of voice information to which an i-th character phase in the M character phrases corresponds is recognized by the electronic apparatus, the electronic apparatus is capable of operate an i-th input object corresponding to the i-th character phase, the symbol i representing any positive integer less than or equal to M.

2. The method of claim 1, wherein the determining a current application corresponding to a current application interface on the display unit as a first application includes:
obtaining at least one active application that is running in the electronic apparatus;
obtaining a recognition parameter information for recognizing what type of application the current application corresponding to the current application interface is from the current application interface; and
determining the current application as the first application from among the at least one active application based on the recognition parameter information.

3. The method of claim 1, wherein the obtaining M input objects on the first application interface comprises:
obtaining K first display objects corresponding to operation instructions on the first application interface;
obtaining J second display objects corresponding to file objects on the first application interface, the sum of K and J being M, and K or J being an integer greater than or equal to zero; and
obtaining the M input objects by obtaining the K first display objects and the J second display objects.

4. The method of claim 3, the processing the M input objects to obtain M pieces of prompt information of M character phrases corresponding to the M input objects comprises:
obtaining K first operation instruction character phrases that are for describing operation instructions and to which K first operation instructions corresponding to the K first display objects correspond based on a correspondence between the display objects and the operation instructions, and obtaining K pieces of prompt information corresponding to the K first operation instruction character phrases based on the K first operation instruction character phrases; and
obtaining J second operation instruction character phrases that are for describing file objects and correspond to the J second display objects, and obtaining J pieces of prompt information corresponding to the J second operation instruction character phrases based on the J second operation instruction character phrases.

5. The method of claim 4, wherein the obtaining K first operation instruction character phrases that are for describing operation instructions and to which K first operation instructions corresponding to the K first display objects correspond based on a correspondence between the display objects and the operation instructions comprises:
obtaining the K first operation instructions corresponding to the K first display objects based on a correspondence between the display objects and the operation instructions;
parsing meaning of the K first operation instructions to obtain K strings of text information for describing meaning of operation instructions; and
obtaining the K first operation instruction character phrases corresponding to the K first display objects based on the K strings of text information, wherein each of the K first operation instruction character phrases is different from the other first operation instruction character phrases in the K first operation instruction character phrases.

6. The method of claim 5, wherein a character length of at least the first one of the K first operation instruction character phrases is less than that of the first string of text information corresponding to the first one of the K first operation instruction character phrases in the K strings of text information.

7. The method of claim 4, wherein the obtaining J second operation instruction character phrases that are for describing file objects and correspond to the J second display objects comprises:
obtaining J strings of text information for describing file objects and corresponding to the J second display objects; and
obtaining J second operation instruction character phrases corresponding to the J second display objects based on the J strings of text information, wherein each of the J second operation instruction character phrases is different from the other second operation instruction character phrases in the J second operation instruction character phrases.

8. The method of claim 1, wherein the processing the M input objects to obtain M pieces of prompt information of M character phrases corresponding to the M input objects comprises:
obtaining a first character string corresponding to one of the M input objects and including S characters;
processing the first character string and generating a second character string corresponding to the first character string, the second character string including T characters, S and T being an integer equal to or greater than one, and T being less than S; and
determining that the second character string corresponds to one of the input objects, the second character string being for triggering an corresponding input object when a voice input is received and voice matching conducted based on the second character string succeeds.

9. The method of claim 8, wherein the processing the first character string and generating a second character string corresponding to the first character string comprises processing the first character string according to a predefined rule and generating the second character string,
the predefined rule is: when a number of characters of the first character string is more than a preset number N, determining that the second character string is the first to N characters of the first character string; when the number of characters of the first character string is less than or equal to the preset number N, determining that the second character string is the S characters of the first character string, N being a positive integer; or
the predefined rule is extracting a keyword in the first character string and determining that the second character string is characters to which the keyword of the first character string corresponds.

10. The method of claim 8, wherein each of the M input objects corresponds to one first character string,
the obtaining the first character string includes obtaining first character strings corresponding to each of the input objects to form a first character string library including a plurality of first character strings;
the processing the first character string and generating a second character string corresponding to the first character string includes processing each of the plurality of first character strings and generating second character strings corresponding to each of the first character strings, so as to form a second character string library including a plurality of second character strings.

11. The method of claim 1, further comprising:
obtaining a triggering instruction for activating a voice recognition function; and
displaying corresponding prompt information at a position of a corresponding input object on the current application interface in response to the triggering instruction.

12. An electronic apparatus including a display unit, the electronic apparatus further comprising:
a determining unit for determining a current application corresponding to a current application interface on the display unit as a first application, the current application interface being a first application interface to which the first application corresponds;
an obtaining unit for obtaining M input objects on the first application interface, M being an integer equal to or larger than one; and
a processing unit for processing the M input objects to obtain M pieces of prompt information of M character phrases corresponding to the M input objects, the M character phrases being capable of being displayed on the display unit, wherein after an i-th piece of voice information to which an i-th character phase in the M character phrases corresponds is recognized by the electronic apparatus, the electronic apparatus is capable of operating an i-th input object corresponding to the i-th character phase, the symbol i representing any positive integer less than or equal to M.

13. The electronic apparatus of claim 12, wherein the determining unit comprises:
a first obtaining sub-unit for obtaining at least one active application that is running in the electronic apparatus;
a second obtaining sub-unit for obtaining recognition parameter information for recognizing what type of application the current application corresponding to the current application interface is from the current application interface; and
a determining sub-unit for determining the current application as the first application from among the at least one active application based on the recognition parameter information.

14. The electronic apparatus of claim 12, wherein the obtaining unit comprises:
a third obtaining sub-unit for obtaining K first display objects corresponding to operation instructions on the first application interface;
a fourth obtaining sub-unit for obtaining J second display objects corresponding to file objects on the first application interface, the sum of K and J being M, and K or J being an integer greater than or equal to zero; and
a fifth obtaining sub-unit for obtaining the M input objects by obtaining the K first display objects and the J second display objects.

15. The electronic apparatus of claim 12, wherein the processing unit comprises:
a first processing sub-unit for, based on a correspondence between the display objects and the operation instructions, obtaining K first operation instruction character phrases that are for describing operation instructions and to which K first operation instructions corresponding to the K first display objects correspond, and for obtaining K pieces of prompt information corresponding to the K first operation instruction character phrases based on the K first operation instruction character phrases; and
a second processing sub-unit for obtaining J second operation instruction character phrases that are for describing file objects and correspond to the J second display objects, and obtaining J pieces of prompt information corresponding to the J second operation instruction character phrases based on the J second operation instruction character phrases.

16. The electronic apparatus of claim 15, wherein the first processing sub-unit comprises:
a first obtaining module for obtaining the K first operation instructions corresponding to the K first display objects based on a correspondence between the display objects and the operation instructions;
a parsing module for parsing meaning of the K first operation instructions to obtain K strings of text information for describing meaning of operation instructions;
a second obtaining module for obtaining the K first operation instruction character phrases corresponding to the K first display objects based on the K strings of text information, wherein each of the K first operation instruction character phrases is different from the other first operation instruction character phrases in the K first operation instruction character phrases; and
a third obtaining module for obtaining K pieces of prompt information corresponding to the K first operation instruction character phrases based on the K first operation instruction character phrases.

17. The electronic apparatus of claim 16, wherein character length of at least the first one of the K first operation instruction character phrases is less than that of the first string of text information corresponding to the first one of the K first operation instruction character phrases in the K strings of text information.

18. The electronic apparatus of claim 15, wherein the second processing sub-unit comprises:
a fourth obtaining module for obtaining J strings of text information describing file objects and corresponding to the J second display objects;
a fifth obtaining module for obtaining J second operation instruction character phrases corresponding to the J second display objects based on the J strings of text information, wherein each of the J second operation instruction character phrases is different from the other second operation instruction character phrases in the J second operation instruction character phrases; and
a sixth obtaining module for obtaining J pieces of prompt information corresponding to the J second operation instruction character phrases based on the J second operation instruction character phrases.

19. The electronic apparatus of claim 12, wherein the processing unit comprises:
a first sub-unit for obtaining a first character string corresponding to one of the M input objects, the first character string including S characters;
a second sub-unit for processing the first character string and generating a second character string corresponding to the first character string, the second character string including T characters, S and T being an integer equal to or greater than one, and T being less than or equal to S; and
a third sub-unit for determining that the second character string corresponds to one of the input objects, the second character string being for triggering an corresponding input object when a voice input is received and voice matching conducted based on the second character string succeeds.

20. The electronic apparatus of claim 19, wherein the second sub-unit processes the first character string according to a predefined rule and generating the second character string,
the predefined rule is when a number of characters of the first character string is more than a preset number N, determining that the second character string is the first to N characters of the first character string; when the number of characters of the first character string is less than or equal to the preset number N, determining that the second character string is the J characters of the first character string, N being a positive integer; or
the predefined rule is extracting a keyword in the first character string and determining that the second character string is characters to which the keyword of the first character string corresponds.

21. The electronic apparatus of claim 20, wherein each of the M input objects corresponds to one first character string,
the first sub-unit can obtain the first character string by obtaining first character strings corresponding to each of the input objects to form a first character string library including a plurality of first character strings; and
the second sub-unit processes each of the plurality of first character strings and generates second character strings corresponding to each of the first character strings, so as to form a second character string library including a plurality of second character strings.

22. The electronic apparatus of claim 12, further comprising:
a voice activating unit for obtaining a triggering instruction for activating a voice recognition function; and
a prompt displaying unit for displaying corresponding prompt information at a position of a corresponding input object on the current application interface in response to the triggering instruction.
